(19) United States
(12) Patent Application Publication
(10) Pub. No.: US 2003/0210659 A1
(43) Pub. Date: Nov. 13, 2003

(54) TFO communication apparatus with codec mismatch resolution and/or optimization logic

(76) Inventors: Chung Cheung C. Chu, Brossard (CA); Rafi R. Rabipour, Cote St-Luc (CA); Peter P. Yue, St-Laurent (CA)

Correspondence Address: SMART & BIGGAR, Suite 3400, 1000 de la Gauchetiere Street West, Motreal, QC, H3B 4W5, CA

(21) Appl. No.: 10/231,185

(22) Filed: Aug. 30, 2002

Related U.S. Application Data
(60) Provisional application No. 60/376,880, filed on May 2, 2002.

(51) Int. Cl. H04B 7/216

(52) U.S. Cl. 370/320

(57) ABSTRACT

An audio communication apparatus having a first interface for communicating with a first remote entity that has a plurality of codecs that can be selectively enabled to process audio data, and a second interface for communicating with a second remote entity. The audio communication apparatus has a control entity for negotiating a TFO connection with the second remote entity by exchanging TFO control data with the second remote entity. During this exchange, the second remote entity sends to the control entity TFO control data conveying information identifying one or more codecs. The control entity includes a codec selector to select at least one codec of the first remote entity for processing audio data. The codec selection is based at least in part on the one or more codecs identified in the TFO control data sent by the second remote entity to the control entity and by the codecs available at the first remote entity. When the selection is made, the control entity sends control information to the first remote entity to cause the first remote entity to enable the codec selected by the codec selector for processing audio data.

### FIELD OF THE INVENTION

The invention relates to audio communication, and in particular to communication devices using codecs and capable of negotiating a TFO operation. More specifically, the invention provides a novel codec selection mechanism for resolving potential codec mismatch situations and/or selection of codecs to process the audio data such as to enhance voice quality.

### BACKGROUND OF THE INVENTION

Two classes of solutions to the problem relating to the service quality in call connections involving tandem codecs have already been described and standardized, or are well in their way towards standardization. The earliest method, called Tandem-Free Operation, uses an in-band handshaking protocol to detect the presence of tandem codecs, and then proceeds to insert the compressed speech packet within the 64 kb/s data stream, thus avoiding the extra decompression/compression stage. A more recent approach, called Transcoder-Free Operation, uses out-of-band signaling to detect call scenarios involving codec in tandem at call set-up time. Thereupon action is taken to put in place a direct end-to-end link to provide for a direct exchange of the compressed speech data without the involvement of transcoders between the end equipments.

For the purpose of this description, the acronym “TFO” will be used to designate both tandem free operation methods and transcoder free operation methods. In cases where a distinction needs to be made between these two methods, the respective multiword descriptions will be used.

For more information on the TFO techniques, the reader is invited to refer to the following documents that are hereby incorporated by reference:

1. TIA/EIA-895, “CDMA Tandem Free Operation”, March 2002;

2. TIA/EIA/IS-893 “Selectable Mode Vocoder Service Option for Wideband Spread Spectrum Communication”;

3. TIA/EIA/IS-127, “Enhanced Variable Rate Codec, Speech Service Option 3 Wideband Spread Spectrum Digital Systems”;

4. TIA/EIA/IS-733, “High Rate Speech Service Option 17 for Wideband Spread Spectrum Communication Systems”;

5. TIA/EIA-96C, “Speech Service Option Standard for Wideband Spread Spectrum Systems”;

6. 3^{rd} generation partnership project, Technical specification group (TSG) RAN3, Transcoder free operation (3GPP TR 25.953 V4.0.0 (2001-03));

7. 3^{rd} generation partnership project, Technical specification group services and system aspects, Inband tandem free operation (TFO) of speech codecs, service description—Stage 3 (3GPP TS 28.062 V5.0.0 (2002-03)).

8. GSM 08.62, “Inband Tandem Free Operation (TFO) of Speech Codecs”, Release 1998;

Tandem free operation between two entities requires a proper codec selection mechanism such that the audio data encoded at one end of the connection will be adequately decoded at the other end. The currently available CDMA tandem free operation protocols do not provide satisfactory codec selection mechanisms. This may result into codec mismatch problems rendering tandem free operation impossible. In instances where tandem free operation is possible and both entities support interoperable codecs, the codecs enabled may not be those that provide the best audio quality.

Against this background, it appears that a need exists in the industry to provide audio communication devices and components thereof that can negotiate a TFO connection and that feature a codec selection mechanism allowing to avoid or at least reduce the difficulties associated with prior art devices.

### SUMMARY OF THE INVENTION

Under a first broad aspect, the invention provides an audio communication apparatus having a first interface for communicating with a first remote entity that has a plurality of codecs that can be selectively enabled to process audio data, and a second interface for communicating with a second remote entity. The first entity has at least one codec selected in the group consisting of SMV, EVRC, Q13 and Q8. The audio communication apparatus has a control entity for negotiating a TFO connection with the second remote entity by exchanging TFO control data with the second remote entity. The second remote entity can send to the control entity TFO control data conveying information identifying one or more codecs.

In a specific example of implementation, the control entity includes a codec selector to select at least one codec of the first remote entity for processing audio data. The codec selection is based at least in part on the one or more codecs identified in the TFO control data sent by the second remote entity to the control entity and by the codecs available at the first remote entity. When the selection is made, the control entity sends control information to the first remote entity to cause the first remote entity to enable the codec selected by the codec selector for processing audio data.

In a specific and non-limiting example of implementation, the codec selector applies a set of rules that determine which codec should be used for processing audio data, in dependence of the specific capabilities of both entities. The control entity has a data structure stored in a data storage medium that includes a plurality of entries. Those entries include codecs that can be selected by the codec selector. The entries are related to respective codec combinations that may exist at both entities of the TFO connection. During TFO negotiation, the codec selector, which is aware of the codec capabilities of the first remote entity, receives the TFO control data from the second remote entity that contains information identifying one or more codecs. The control entity locates in the data structure the set of codecs of the first remote entity and the set received from the second remote entity. The entry that is related to these two sets contains the codec that should be used.

Note that the selected entry may contain more than one codec that could be used. If this is the case, additional rules may then be applied to arrive at a definite codec selection. After a single codec has been selected, the control entity sends control information to the first remote entity such as to enable the selected codec.

In the case when the audio information issued by the first remote entity is sent to a third remote entity and transits via the audio communication apparatus and the second remote entity, the second remote entity performs the same codec selection described above. Since both the audio communication apparatus and the second remote entity apply coherent codec selection rules, both ends should select the same codec given compatible codec capabilities at each end. By “coherent” is meant that the rules are such that when applied to the same codec information, they will result in the selection of the same codec or at least a compatible codec. Advantageously, the rules are identical such that the selection process performed at one end is the same as the selection process performed at the other end. This feature is advantageous since it does not require communication between the audio communication apparatus and the second remote entity for negotiating which codec is to be used. Note, however, that the invention is not limited to this feature. Variants where some control information is sent between the audio communication apparatus and the second remote entity regarding which codec is to be used, is within the scope of this invention. An example of this control information is messages to notify the other partner about the codec that has been selected such as to positively confirm that both sides select the same or at the very least compatible codecs.

### BRIEF DESCRIPTION OF THE DRAWINGS

A detailed description of examples of implementation of the present invention is provided hereinbelow with reference to the following drawings, in which:

FIG. 1 is a block diagram of network components involved in a mobile-to-mobile call;

FIG. 2 is a more detailed block diagram of a base station and of one of the mobiles involved in the mobile-to-mobile call.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

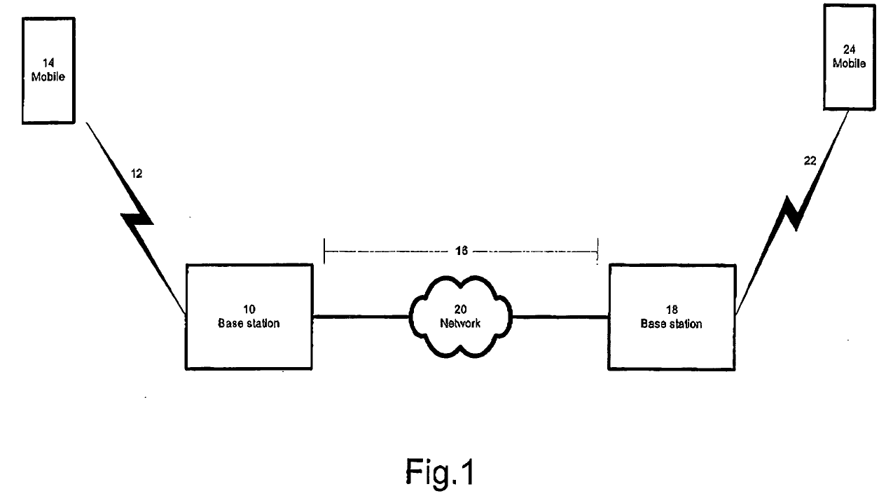

FIG. 1 illustrates a block diagram of the network components involved in a mobile-to-mobile audio call. The network components include a communication apparatus implemented as a base station 10 that establishes a CDMA communication link 12 with a mobile station 14, the communication link 12 being effected over the air interface. The base station 10 establishes a communication link 16 with a remote base station 18. The communication link 16 can be made through a network 20, such as the PSTN, via a direct cable connection, other TFO compliant devices or the air interface. Finally, the base station 18 establishes a CDMA communication link 22 with a mobile station 24 over the air interface.

Note that the CDM communication links 12 and 22 are implementation details and they are not essential to the invention. Applications where the entities 14 and 24 communicate with the respective communication apparatuses 10 and 18 by communication links that are wireless but not CDMA are encompassed by the present inventive concept. In addition, applications where the communication links 12 and 22 are not wireless but of a wire line type can be envisaged without departing from the spirit of the invention.

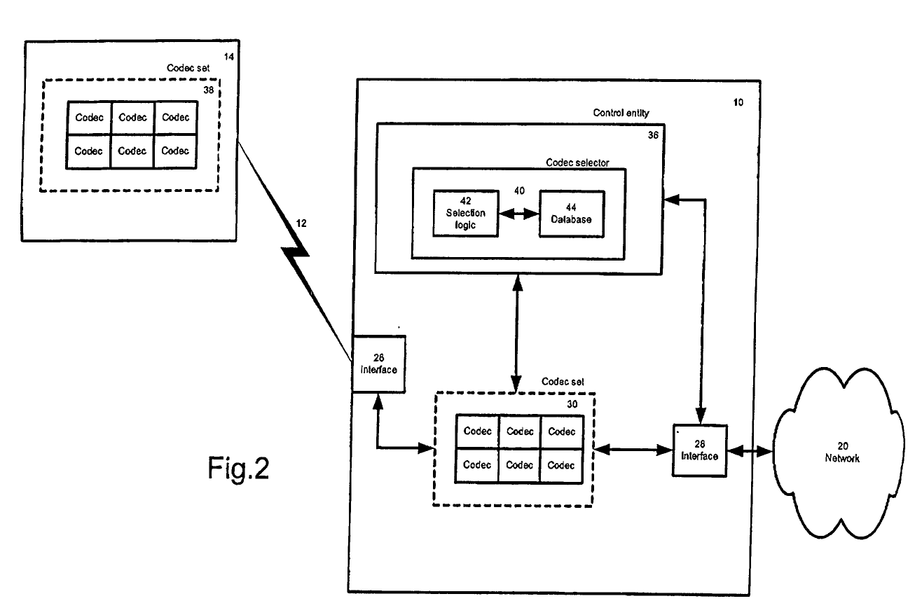

FIG. 2 is a more detailed block diagram of the base station 10 and the mobile station 14. The block diagram of the base station 18 and the mobile station 24 is identical and for that reason it is not shown.

The base station 10 includes an interface 26 through which the CDMA communication link 12 with the mobile station 14 is established. Similarly, the communication between the base station 10 and the remote base station 18 is established via an interface 28. An audio codec set 30 communicates with the interfaces 26 and 28. The codec set 30 includes a plurality of codecs that can be selectively enabled to process the audio data. Examples of codecs that can be included in the codec set 30 are SMV, EVRC, Q13 or Q8. The reader will appreciate that other codecs can be used, without departing from the spirit of this invention.

A control entity 36 controls the operation of the codec set 30, as it will be described in detail later.

The mobile station 14 also has a codec set 38. The codec set 38 also has a number of individual codecs that can be selectively enabled for processing audio data. In the example shown, the codec set 38 is the same as the codec set 30. This is not a necessity; the codec sets 30 and 38 may have different capabilities without departing from the spirit of the invention.

The control entity 36 that may be implemented in software, hardware or a combination of software and hardware is designed to negotiate with the control entity of the remote base station 18 a tandem free operation, such that audio data encoded at the mobile station 14 is passed without decoding by the base station 10 to the remote base station 18. Similarly, under tandem free operation, audio data received from the remote base station 18 in encoded format is passed to the mobile station 14 without encoding by the base station 10.

The control entity 36 negotiates the tandem free operation with the control entity of the remote base station 18 by the exchange of tandem free operation control data with the remote base station 18. The tandem free operation control data is sent via in-band signals over the communication link 16. Alternatively, the tandem free operation control data can be sent via out-of-band signals, or a combination of in-band and out-of-band signals.

The specifics of the protocol used to negotiate the tandem free operation are not an essential element of this invention. A number of different tandem free operation protocols can be used, as currently known or likely to be developed in the future.

In the course of the tandem free operation negotiation, the control entity 36 sends a message to the remote base station 18 that includes information identifying one or more of the codecs that can be selectively enabled at both the base station 10 and the mobile station 14. Here it is assumed that the control entity 36 is aware of the capabilities of the codec set 38. The same operation is performed by the remote base station 18. Advantageously, the specific protocol used may provide for acknowledgement messages to be sent for each message identifying the capabilities of mobile stations 14, 24.

Once each base station is aware of the codec capabilities of the remote base station, this information is submitted to a codec selector 40 that is part of the control entity. The codec selector 40 implements a set of rules that determine which codec to enable given the capabilities of each mobile station 14, 24. The rules implemented by each base station 10, 18 are coherent, and preferably identical.

In one specific form of implementation, the codec selector 40 includes selection logic 42 and a data storage medium 44 holding a data structure. The data structure contains a plurality of entries identifying codecs to be enabled. The entries are related to respective codes set combinations supported by each wireless link 12,22, in other words, base station and mobile entity pair. For example, in the case of the base station 10, the codec selection logic 42 identifies in the data structure the entry associated to the codec capabilities supported by the base station 10 and the mobile station 14, and the codec capabilities supported by the base station 18 and the mobile station 24. This entry contains the codec that should be enabled.

An example of this data structure is shown in the table 1 below. This example applies to the specific scenario described earlier, where the communication links 12 and 22 are CDMA links and where the codec set supported on each side of the network includes an SMV codec, an EVRC codec and a Q13 codec, or a sub-combination of these three codecs. Codec sets that include a Q8 codec are managed by using a separate data structure illustrated in Table 2.

TABLE 1

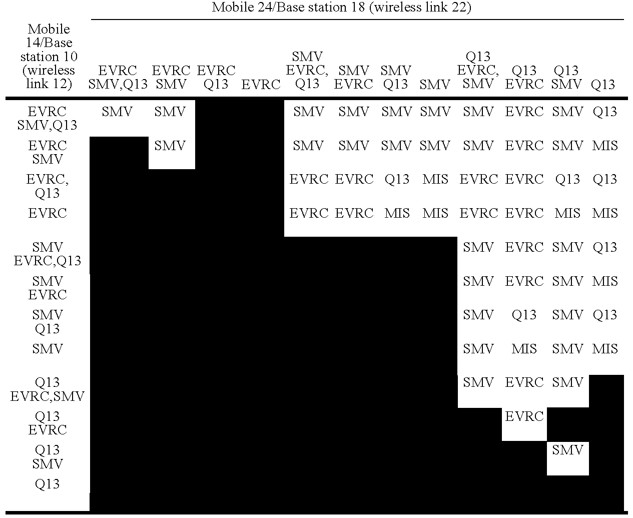

The first column of Table 1 contains in each cell, a definition of the codec currently used by base station 10 and mobile 14 (active codec) followed on the next line by the list of supported codecs (the set of codecs that can be enabled in place of the active codec). It should be noted that a codec set appearing in a given cell is a set in which the individual codecs can be enabled to transmit audio data over the wireless link. In other words, each codec in the set exists and can be enabled at the mobile 14 and at the base station 10. In the case where one of the entities (mobile 14, base station 10) has one or more additional codecs that do not exist or cannot be enabled in the other entity (mobile 14, base station 10), then the one or more additional codecs are disregarded when working with the table.

The first row contains similar information for wireless link 22, in other words base station 18 and mobile 24. The matrix elements that form the entries of the data structure discussed earlier indicate the change to be made to the currently used codec. For example, if a matrix element lists <<SMV>>, both mobile and base station pairs shall use the SMV codec. The empty areas are intentionally left blank, since it would otherwise contain redundant information. The ‘=’ sign indicates that no mismatch is present or no further optimization is feasible. The ‘MIS’ indicates that the mismatch cannot be resolved or optimization is not viable.

TABLE 2

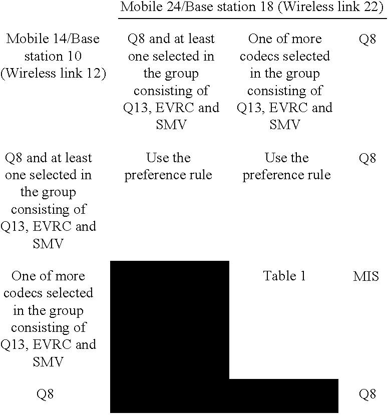

The preference rule states that if:

1) The two sides have a common codec, other than the Q8 codec, selected in the group consisting of Q13, EVRC and SMV, use that codec instead of the Q8 codec. If the two sides have two or more codecs in common, select the codec that has the highest preference rank, where the preference ranking is as follows;

i) SMV (the highest rank);

ii) EVRC; and

iii) Q13

In the case where each side contains a Q8 and other codecs but only Q8 is the common codec, then the Q8 codec is ignored and Table 1 is consulted, resulting in ‘MIS’.

Or

2) Only one of the sides has the Q8 codec and the two sides have a common codec selected in the group consisting of Q13, EVRC and SMV, use that common codec. If the two sides have two or more codecs in common, select the codec that has the highest preference rank, where the preference ranking is as follows:

i) SMV (the highest rank);

ii) EVRC; and

iii) Q13

A specific example will now be described illustrating how the data structures in Tables 1 and 2 are used. Assume that a call has been established between mobile entity 14 and the mobile entity 24 via the base stations 10 and 18. The mobile 14 has a codec set 38 including the codecs SMV, EVRC, Q13 and Q8. The base station has a codec set 30 including SMV, EVRC and Q13.

The set of codecs at the base station 18 includes an SMV, EVRC and Q13. The same set of codecs is present at the mobile 24.

The call is established in a non-tandem free operation moode, such that audio data is encoded at the mobile 14, decoded at the base station 10, sent in PCM format to the base station 18 where it is encoded and then sent to the mobile 24 where it is decoded. As part of the normal call set-up operation, the mobile entity 14 and the base station 10 pair select the EVRC codec for the encoding/decoding. The same codec is used by the base station 18/ mobile 24 pair.

Sometime after the call is established, the control entity 36 starts negotiation with the control entity of the base station 18. Tandem free operation is established and the EVRC codecs in the base stations 10 and 18 are deactivated such that data encoded by the EVRC codec at the mobile 14 is sent without decoding to the mobile 24 where it is decoded by the local EVRC codec.

During the tandem free operation negotiation, or after the negotiation has been completed, the control entity 36 of the base station 10 and the control entity of the base station 18 exchange tandem free operation control data such as to advise each other of the codec capabilities of the respective mobiles 14,24 and base station 10,18 pairs. In this example, the control entity 36 of the base station 10 sends a message to the control entity of the base station 18 that the codecs that can be enabled at the mobile 14 and at the base station 10 are SMV, EVRC and Q13. Optionally, the message can include information about, which one of these codecs is being currently used for processing the audio stream. This information is not necessary since it can be inferred; each base station 10, 18 “knows” which codec the respective mobile entity 14, 24 is presently using.

At this point, the codec selection logic 42 consults the database 44. Under “Mobile 14/ base station 10” the first cell is selected that corresponds to the codec set of the mobile 14 (EVRC, SMV and Q13) and base station 10 where EVRC is presently active. Under “Mobile 24/ base station 18” the first cell is also selected that corresponds to the codec set of the mobile 24 (EVRC, SMV and Q13) and the base station 18 and where EVRC is presently active. The table indicates that for those conditions, the mobile 14 should switch to an SMV codec.

The same codec selection operation is performed at the base station 18 where the SMV codec is also selected. As indicated earlier, it is within the scope of this invention to exchange acknowledgement messages between the base stations 10, 18 to confirm the codec selection at each end. At this point each base station 10, 18 sends control signals to the respective mobile 14, 24 such that the mobiles 14, 24 switch to the SMV codec.

Note that the switching may require exiting the tandem free operation mode temporarily. Accordingly, the control entity 36 of each base station 10, 18 sends control signals to the respective codec set 30 such that the codec that will be enabled if the tandem free operation mode is to be exited is the SMV codec.

In the above example, the Table 1 is used to provide voice quality enhancement once a tandem free operation connection has been established. The same table can also be used to provide codec mismatch resolution such as to allow tandem free operation establishment. Consider the example where the mobile 14 and the base station 10 pair share a codec set having an SMV, EVRC and a Q13 codec that can be enabled, and they are currently using the SMV codec. The mobile 24 and the base station 18 share a codec set that has the codecs Q13 and EVRC that can be enabled and they are currently using the Q13 codec. In this scenario, the table indicates that all the entities involved in the call should switch to the EVRC codec such as to establish a tandem free operation connection.

This example shows that the table can be used during tandem free connection establishment and not only as an optimization tool designed to enhance voice quality.

It will be noted that the logic built into this table is based on an order of preference of codecs: an SMV codec is preferred over an EVRC codec which is preferred over a Q13 codec and which is preferred over a Q8 codec. The reader will appreciate that codec selection rules based on this order of preference can be implemented differently from the table discussed earlier, without departing from the spirit of the invention.

Several variants can be considered without departing from the spirit of the invention. The example above was given in the context of a tandem-free operation in a CDMA mobile-to-mobile call. The same principle applies to a transcoder-free operation or other TFO based operations.

In another example, the network 20 may comprise other signal processing entities capable of TFO operation. These entities become transparent TFO in-path-equipments to allow direct TFO negotiation and codec selection based on the defined rules between base station 10 and 18.

In another example, the base station 10 can be communicating with a remote entity (not shown) over the network 20. Such remote entity can be in the form of a gateway. In a non-TFO mode of operation, the mobile 14 sends encoded audio information to the base station 10, where the encoded audio information is decoded. The decoded audio information is then passed via the network 20 to the gateway, which, in turn passes the decoded audio information to a telephone. It should be noted that in a non-TFO mode of operation there is no active codec at the gateway.

If a TFO mode of operation is desired, TFO is negotiated between the base station 10 and the gateway. The TFO negotiation selects a codec common to mobile 14, base station 10 and the gateway based on the rules defined earlier, with one exception however. In light of the fact that there is no active codec at the gateway in the non-TFO mode of operation, one of the codecs supported by the gateway is designated as a default codec. This default codec is used as the “active” codec on the gateway side when using the Tables 1 and 2 above. Accordingly, for the purpose of this specification, “active” codec shall designate a codec in a set of codecs that is activated while one or more of the other codecs in the set are inactive, or to a codec in a set of codecs that is inactive but expressly marked or identified as a default codec for using as an “active” codec entry when working with the data structures implementing Tables 1 and 2.

The gateway is configured in a similar manner to the base station 10 as far as the codec selection function is concerned, in other words, the gateway has a control entity and a codec set, as described previously.

After successful TFO negotiation, the selected codec is deactivated in base station 10 and activated in the gateway. Note that after a codec has been selected, in contrast to the base station 10, the gateway enables this codec internally but does not send any control message to activate a codec in the telephone, since the telephone is assumed to have no coding capability in this example.

During the TFO-mode of operation, audio data encoded at the mobile 14 passes via base station 10 without decoding, travels to the gateway and there it is decoded. The decoded audio information is then passed to the telephone. Audio data from the telephone is encoded by the codec in the gateway. The compressed audio data passes via base station 10 without decoding to the mobile 14, where it is decoded.

The reader will appreciate that in the variant described above, the information identifying one or more codecs in the TFO control data received by the base station 10 and sent by the gateway relates to codecs that will be enabled only after the TFO connection is effected.

In another possible variant, the a remote entity that sends TFO control data with the information identifying one or more codecs may not need codecs at all and the codecs identified may be codecs from a third entity controlled by the remote entity. In other words, the remote entity negotiates the TFO connection on behalf of the third entity and performs the codec selection also on behalf of the third entity. Once the codec selection has been effected, the remote entity sends control data to the third entity to indicate to the third entity which codec to use. In such instance, the audio data does not need to transit via the remote entity.

In yet another variant, codec selection parameters other than only the codec capabilities at each end of the communication can be considered in selecting the codec to enable for processing audio data

Although various embodiments have been illustrated, this was for the purpose of describing, but not limiting, the invention. Various modifications will become.apparent to those skilled in the art and are within the scope of this invention, which is defined more particularly by the attached claims.

1) An audio communication apparatus, comprising:
a) a first interface for communicating with a first remote entity, the first remote entity including a plurality of codecs that can be selectively enabled to process audio data;
b) the plurality of codecs of the first remote entity that can be selectively enabled including an EVRC codec, an SMV codec and a Q13 codec, the EVRC codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying an EVRC codec, an SMV codec and a Q13 codec, the EVRC codec being active;
f) said control entity including a codec selector to select the SMV codec of the first remote entity for processing audio data;
g) said control entity operative for sending control information to the first remote entity to cause the first remote entity to enable the SMV codec for processing the audio data.

2) A communication apparatus as defined in claim 1, wherein;
a) the TFO control data sent by the second remote entity to said control entity conveys information identifying the EVRC codec, the SMV codec and the Q13 codec that reside at the second remote entity and where the EVRC codec is active;
b) the plurality of codecs of the first remote entity that can be selectively enabled consists of the EVRC codec, the SMV codec and the Q13 codec;
c) the TFO control data sent by the second remote entity to said control entity conveys information identifying only the EVRC codec, the SMV codec, the Q13 and no other codec;
d) the first interface communicates with the first remote entity via a wireless CDMA link.

3) An audio communication apparatus, comprising:
a) a first interface for communicating with a first remote entity, the first remote entity including a plurality of codecs that can be selectively enabled to process audio data;
b) the plurality of codecs of the first remote entity that can be selectively enabled including an EVRC codec, an SMV codec and a Q13 codec, the EVRC codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying an EVRC codec and an SMV codec, the EVRC codec being active;
f) said control entity including a codec selector to select the SMV codec of the first remote entity for processing audio data;
g) said control entity operative for sending control information to the first remote entity to cause the first remote entity to enable the SMV codec for processing the audio data.

4) A communication apparatus as defined in claim 3, wherein;
a) the TFO control data sent by the second remote entity to said control entity conveys information identifying the EVRC codec and the SMV codec that reside at the second remote entity and where the EVRC codec is active;
b) the plurality of codecs of the first remote entity that can be selectively enabled consists of the EVRC codec, the SMV codec and the Q13 codec;
c) the TFO control data sent by the second remote entity to said control entity conveys information identifying only the EVRC codec, the SMV codec and no other codec;
d) the first interface communicates with the first remote entity via a wireless CDMA link.

5) An audio communication apparatus, comprising:
a) a first interface for communicating with a first remote entity, the first remote entity including a plurality of codecs that can be selectively enabled to process audio data;
b) the plurality of codecs of the first remote entity that can be selectively enabled including an EVRC codec, an SMV codec and a Q13 codec, the EVRC codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying an SMV codec, an EVRC codec and a Q13 codec, the SMV codec being active;
f) said control entity including a codec selector to select the SMV codec of the first remote entity for processing audio data;
g) said control entity operative for sending control information to the first remote entity to cause the first remote entity to enable the SMV codec for processing the audio data.

6) A communication apparatus as defined in claim 5, wherein;
a) the TFO control data sent by the second remote entity to said control entity conveys information identifying an SMV codec, an EVRC codec and a Q13 codec that reside at the second remote entity and where the SMV codec is active;
b) the plurality of codecs of the first remote entity that can be selectively enabled consists of the EVRC codec, the SMV codec and the Q13 codec;
c) the TFO control data sent by the second remote entity to said control entity conveys information identifying only the SMV codec, the EVRC codec, the Q13 codec and no other codec;
d) the first interface communicates with the first remote entity via a wireless CDMA link.

7) An audio communication apparatus, comprising:
a) a first interface for communicating with a first remote entity, the first remote entity including a plurality of codecs that can be selectively enabled to process audio data;
b) the plurality of codecs of the first remote entity that can be selectively enabled including an EVRC codec, an SMV codec and a Q13 codec, the EVRC codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying an SMV codec and an EVRC codec, the SMV codec being active;
f) said control entity including a codec selector to select the SMV codec of the first remote entity for processing audio data;
g) said control entity op(erative for sending control information to the first remote entity to cause the first remote entity to enable the SMV codec for processing the audio data.

8) A communication apparatus as defined in claim 7, wherein;
a) the TFO control data sent by the second remote entity to said control entity conveys information identifying an SMV codec and an EVRC codec that reside at the second remote entity and where the SMV codec is active;
b) the plurality of codecs of the first remote entity that can be selectively enabled consists of the EVRC codec, the SMV codec and the Q13 codec;
c) the TFO control data sent by the second remote entity to said control entity conveys information identifying only the SMV codec, the EVRC codec, and no other codec;
d) the first interface communicates with the first remote entity via a wireless CDMA link.

9) An audio communication apparatus, comprising:
a) a first interface for communicating with a first remote entity, the first remote entity including a plurality of codecs that can be selectively enabled to process audio data;
b) the plurality of codecs of the first remote entity that can be selectively enabled including an EVRC codec, an SMV codec and a Q13 codec, the EVRC codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying a Q13 codec, an EVRC codec and an SMV codec, the Q13 codec being active;
f) said control entity including a codec selector to select the SMV codec of the first remote entity for processing audio data;
g) said control entity operative for sending control information to the first remote entity to cause the first remote entity to enable the SMV codec for processing the audio data.

10) A communication apparatus as defined in claim 9, wherein;
a) the TFO control data sent by the second remote entity to said control entity conveys information identifying the Q13 codec, the EVRC codec and the SMV codec that reside at the second remote entity and where the Q13 codec is active;
b) the plurality of codecs of the first remote entity that can be selectively enabled consists of the EVRC codec, the SMV codec and the Q13 codec;
c) the TFO control data sent by the second remote entity to said control entity conveys information identifying only the Q13 codec, the EVRC codec, the SMV codec, and no other codec;
d) the first interface communicates with the first remote entity via a wireless CDMA link.

11) An audio communication apparatus, comprising:
a) a first interface for communicating with a first remote entity, the first remote entity including a plurality of codecs that can be selectively enabled to process audio data;
b) the plurality of codecs of the first remote entity that can be selectively enabled including an EVRC codec and an SMV codec, the EVRC codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying an SMV codec, an EVRC codec and a Q13 codec, the SMV codec being active;
f) said control entity including a codes selector to select the SMV codec of the first remote entity for processing audio data;
g) said control entity operative for sending control information to the first remote entity to cause the first remote entity to enable the SMV codec for processing the audio data.

12) A communication apparatus as defined in claim 11, wherein;
a) the TFO control data sent by the second remote entity to said control entity conveys information identifying the SMV codec, the EVRC codec and the Q13 codec that reside at the second remote entity and where the SMV codec is active;
b) the plurality of codecs of the first remote entity that can be selectively enabled consists of the EVRC codec and the SMV codec;
c) the TFO control data sent by the second remote entity to said control entity conveys information identifying only the SMV codec, the EVRC codec, the Q13 codec and no other codec;
d) the first interface communicates with the first remote entity via a wireless CDMA link.

13) An audio communication apparatus, comprising:
a) a first interface for communicating with a first remote entity, the first remote entity including a plurality of codecs that can be selectively enabled to process audio data;
b) the plurality of codecs of the first remote entity that can be selectively enabled including an EVRC codec and an SMV codec, the EVRC codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying an EVRC codec and an SMV codec, the EVRC codec being active;
f) said control entity including a codec selector to select the SMV codec of the first remote entity for processing audio data;
g) said control entity operative for sending control information to the first remote entity to cause the first remote entity to enable the SMV codec for processing the audio data.

14) A communication apparatus as defined in claim 13, wherein;
a) the TFO control data sent by the second remote entity to said control entity conveys information identifying the EVRC codec and the SMV codec that reside at the second remote entity and where the EVRC codec is active;
b) the plurality of codecs of the first remote entity that can be selectively enabled consists of the EVRC codec and the SMV codec;
c) the TFO control data sent by the second remote entity to said control entity conveys information identifying only the EVRC codec, the SMV codec and no other codec;
d) the first interface communicates with the first remote entity via a wireless CDMA link.

15) An audio communication apparatus, comprising:
a) a first interface for communicating with a first remote entity, the first remote entity including a plurality of codecs that can be selectively enabled to process audio data;
b) the plurality of codecs of the first remote entity that can be selectively enabled including an EVRC codec and an SMV codec, the EVRC codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying an SMV codec and an EVRC codec, the SMV codec being active;
f) said control entity including a codec selector to select the SMV codec of the first remote entity for processing audio data;
g) said control entity operative for sending control information to the first remote entity to cause the first remote entity to enable the SMV codec for processing the audio data.

16) A communication apparatus as defined in claim 15, wherein;
a) the TFO control data sent by the second remote entity to said control entity conveys information identifying the SMV codec and the EVRC codec that reside at the second remote entity and where the SMV codec is active;
b) the plurality of codecs of the first remote entity that can be selectively enabled consists of the EVRC codec and the SMV codec;
c) the TFO control data sent by the second remote entity to said control entity conveys information identifying only the SMV codec, the EVRC codec and no other codec;
d) the first interface communicates with the first remote entity via a wireless CDMA link.

17) An audio communication apparatus, comprising:
a) a first interface for communicating with a first remote entity, the first remote entity including a plurality of codecs that can be selectively enabled to process audio data;
b) the plurality of codecs of the first remote entity that can be selectively enabled including an EVRC codec and an SMV codec, the EVRC codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying a Q13 codec, an EVRC codec and an SMV codec, the Q13 codec being active;
f) said control entity including a codec selector to select the SMV codec of the first remote entity for processing audio data;
g) said control entity operative for sending control information to the first remote entity to cause the first remote entity to enable the SMV codec for processing the audio data.

18) A communication apparatus as defined in claim 17, wherein;
a) the TFO control data sent by the second remote entity to said control entity conveys information identifying the Q13 codec, the EVRC codec and the SMV codec that reside at the second remote entity and where the Q13 codec is active;
b) the plurality of codecs of the first remote entity that can be selectively enabled consists of the EVRC codec and the SMV codec;
c) the TFO control data sent by the second remote entity to said control entity conveys information identifying only the Q13 codec, the EVRC codec, the SMV codec and no other codec;
d) the first interface communicates with the first remote entity via a wireless CDMA link.

19) An audio communication apparatus, comprising:
a) a first interface for communicating with a first remote entity, the first remote entity including a plurality of codecs that can be selectively enabled to process audio data;
b) the plurality of codecs of the first remote entity that can be, selectively enabled including a Q13 codec, and EVRC codec and an SMV codec, the Q13 codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying a Q13 codec, an EVRC codec and an SMV codec, the Q13 codec being active;
f) said control entity including a codec selector to select the SMV codec of the first remote entity for processing the audio data;
g) said control entity operative for sending control information to the first remote entity to cause the first remote entity to enable the SMV codec for processing the audio data.

20) A communication apparatus as defined in claim 19, wherein;
a) the TFO control data sent by the second remote entity to said control entity conveys information identifying the Q13 codec, the EVRC codec and the SMV codec that reside at the second remote entity and where the Q13 codec is active;
b) the plurality of codecs of the first remote entity that can be selectively enabled consists of the Q13 codec, the EVRC codec and the SMV codec;
c) the TFO control data sent by the second remote entity to said control entity conveys information identifying only the Q13 codec, the EVRC codec, the SMV codec and no other codec;
d) the first interface communicates with the first remote entity via a wireless CDMA link.

21) An audio communication apparatus, comprising;
a) a first interface for communicating with a first remote entity, the first remote entity including a plurality of codecs that can be selectively enabled to process audio data;
b) the plurality of codecs of the first remote entity that can be selectively enabled including a Q13 codec, and EVRC codec and an SMV codec, the Q13 codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying a Q13 codec and an EVRC codec, the Q13 codec being active;
f) said control entity including a codec selector to select the EVRC codec of the first remote entity for processing the audio data;
g) said control entity operative for sending control information to the first remote entity to cause the first remote entity to enable the EVRC codec for processing the audio data.

22) A communication apparatus as defined in claim 21, wherein;
a) the TFO control data sent by the second remote entity to said control entity conveys information identifying the Q13 codec and the EVRC codec that reside at the second remote entity and where the Q13 codec is active;
b) the plurality of codecs of the first remote entity that can be selectively enabled consists of the Q13 codec, the EVRC codec and the SMV codec;
c) the TFO control data sent by the second remote entity to said control entity conveys information identifying only the Q13 codec, the EVRC codec and no other codec;
d) the first interface communicates with the first remote entity via a wireless CDMA link.

23) An audio communication apparatus, comprising;
a) a first interface for communicating with a first remote entity, the first remote entity including a plurality of codecs that can be selectively enabled to process audio data;
b) the plurality of codecs of the first remote entity that can be selectively enabled including a Q13 codec, an EVRC codec and an SMV codec, the Q13 codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying a Q13 codec and an SMV codec, the Q13 codec being active;
f) said control entity including a codec selector to select the SMV codec of the first remote entity for processing the audio data;
g) said control entity operative for sending control information to the first remote entity to cause the first remote entity to enable the SMV codec for processing the audio data.

24) A communication apparatus as defined in claim 23, wherein;
a) the TFO control data sent by the second remote entity to said control entity conveys information identifying the Q13 codec and the SMV codec that reside at the second remote entity and where the Q13 codec is active;
b) the plurality of codecs of the first remote entity that can be selectively enabled consists of the Q13 codec, the EVRC codec and the SMV codec;
c) the TFO control data sent by the second remote entity to said control entity conveys information identifying only the Q13 codec, the SMV codec and no other codec;
d) the first interface communicates with the first remote entity via a wireless CDMA link.

25) An audio communication apparatus, comprising:
a) a first interface for communicating with a first remote entity, the first remote entity including a plurality of codecs that can be selectively enabled to process audio data;
b) the plurality of codecs of the first remote entity that can be selectively enabled including a Q13 codec and an EVRC codec, the Q13 codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying a Q13 codec and an EVRC codec, the Q13 codec being active;
f) said control entity including a codec selector to select the EVRC codec of the first remote entity for processing the audio data;
g) said control entity operative for sending control information to the first remote entity to cause the first remote entity to enable the EVRC codec for processing the audio data.

26) A communication apparatus as defined in claim 25, wherein;
a) the TFO control data sent by the second remote entity to said control entity conveys information identifying the Q13 codec and the EVRC codec that reside at the second remote entity and where the Q13 codec is active;
b) the plurality of codecs of the first remote entity that can be selectively enabled consists of the Q13 codec and the EVRC codec;
c) the TFO control data sent by the second remote entity to said control entity conveys information identifying only the Q13 codec, the EVRC codec and no other codec;
d) the first interface communicates with the first remote entity via a wireless CDMA link.

27) An audio communication apparatus, comprising:
a) a first interface for communicating with a first remote entity, the first remote entity including a plurality of codecs that can be, selectively enabled to process audio data;
b) the plurality of codecs of the first remote entity that can be selectively enabled including a Q13 codec and an SMV codec, the Q13 codec being active;
c) a second interface for communicating with a second remote entity;
d) a control entity operative to negotiate a TFO connection with the remote entity via said second interface by exchanging TFO control data with the second remote entity;
e) said control entity capable of receiving TFO control data including TFO control data sent by the second remote entity to said control entity conveying information identifying a Q13 codec and an SMV codec, the Q13 codec being active;
f) said control entity including a codec selector to select the SMV codec of the first remote entity for processing the audio data;
g) said control entity operative for sending control information to the first remote entity to cause the first remote entity to enable the SMV codec for processing the audio data.

28) A communication apparatus as defined in claim 27, wherein;
a) the TFO control data sent by the second remote entity to said control entity conveys information identifying the Q13 codec and the SMV codec that reside at the second remote entity and where the Q13 codec is active;
b) the plurality of codecs of the first remote entity that can be selectively enabled consists of the Q13 codec and the SMV codec;
c) the TFO control data sent by the second remote entity to said control entity conveys information identifying only the Q13 codec, the SMV codec and no other codec;
d) the first interface communicates with the first remote entity via a wireless CDMA link.

29) A computer readable storage medium including a data structure implementing relationships expressed in the following table:

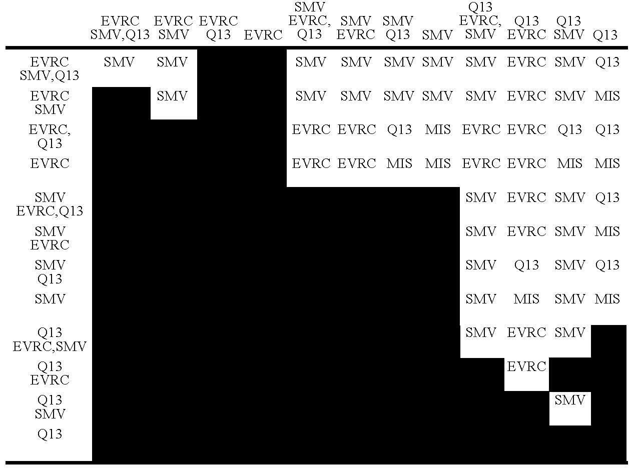

30) In an audio communication system including a first mobile establishing a first wireless connection with a first base station and a second mobile establishing a second wireless connection with a second base station, the use of a data structure stored in a computer readable storage medium implementing relationships expressed in the following table for performing selection of a codec for processing audio data over the first wireless connection: 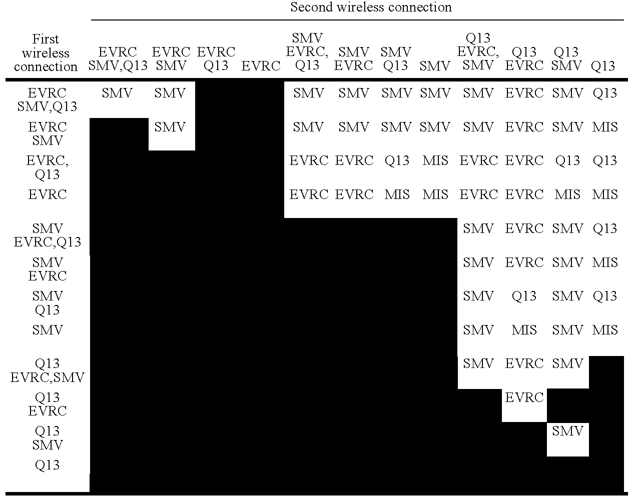
where the first column of the table contains in each cell, a definition of the codec currently used over the first wireless connection followed by a list of codecs that can be enabled in place of the currently used codec;
the first row of the table contains in each cell a definition of the codec currently used over the second wireless connection followed by a list of codecs that can be enabled in place of the currently used codec;
the ‘=’ sign indicates that no mismatch is present or no further optimization is feasible;
the ‘MIS’ indicates that a mismatch cannot be resolved or an optimization is not feasible.

31) In an communication system use of a data structure as defined in claim 30, further implementing the relationships expressed in the following table:

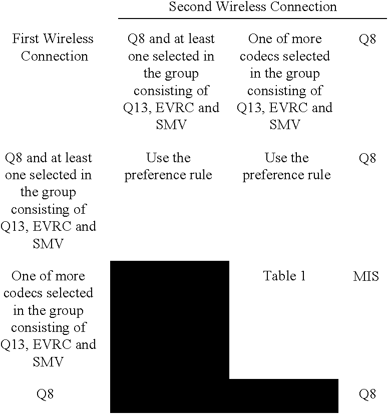

32) An audio communication system including:
a) a first mobile establishing a first wireless connection with a first base station:
b) a second mobile establishing a second wireless connection with a second base station;
c) said first base station including a codec selector for performing selection of a codec for processing audio data sent over the first wireless connection by using logic expressed by the following table: 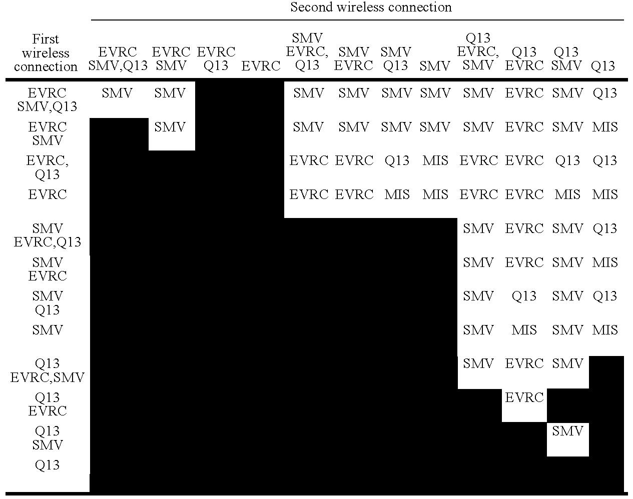
where the first column of the table contains in each cell, a definition of the codec currently used over the first wireless connection followed by a list of codecs that can be enabled in place of the currently used codec;
the first row of the table contains in each cell a definition of the codec currently used over the second wireless connection followed by a list of codecs that can be enabled in place of the currently used codec;
the ‘=’ sign indicates that no mismatch is present; or no further optimization is feasible;
the ‘MIS’ indicates that a mismatch cannot be resolved or an optimization is not feasible.

33) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of an EVRC codec, an SMV codec and a Q13 codec, the EVRC codec being active;
b) the audio communication apparatus including a plurality of codecs that can be selectively enabled to process audio data, the plurality of codecs of the audio communication apparatus that can be selectively enabled consist of an EVRC codec, an SMV codec and a Q13 codec, the EVRC codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.

34) A computer readable storage medium for use in art audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of an EVRC codec, an SMV codec and a Q13 codec, the EVRC codec being active;
b) the audio communication apparatus including a plurality of codecs that can be selectively enabled to process audio data, the plurality of codecs of the audio communication apparatus that can be selectively enabled consist of an EVRC codec, an SMV codec, the EVRC codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.

35) A computer readable storage medium for use in an audio communication apparatus for selecting at least one codec for processing audio data transmitted between the audio communication apparatus and a remote entity;
a) the remote entity, including a plurality of codecs that can be selectively enabled to process audio data, the plurality of codecs of the remote entity that can be selectively enabled consist of an EVRC codec, an SMV codec and a Q13 codec, the EVRC codec being active;
b) the audio communication apparatus including a plurality of codecs that can be selectively enabled to process audio data, the plurality of codecs of the audio communication apparatus that can be selectively enabled consist of an SMV codec, an EVRC codec and a Q13 codec, the SMV codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.

36) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of an EVRC codec, an SMV codec and a Q13 codec, the EVRC codec being active;
b) the audio communication apparatus including a plurality of codecs that can be selectively enabled to process audio data, the plurality of codecs of the audio communication apparatus that can be selectively enabled consist of an SMV codec and an EVRC codec, the SMV codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.

37) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of an EVRC codec, an SMV codec and a Q13 codec, the EVRC codec being active;
b) the audio communication apparatus including a plurality of codecs that can be selectively enabled to process audio data, the plurality of codecs of the audio communication apparatus that can be selectively enabled consist of a Q13 codec, an EVRC codec and an SMV codec, the Q13 codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.

38) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of an EVRC codec and an SMV codec, the EVRC codec being active;
b) the audio communication apparatus including a plurality of codecs that can be selectively enabled to process audio data, the plurality of codecs of the audio communication apparatus that can be selectively enabled consist of an SMV codec, an EVRC codec and a Q13 codec, the SMV codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.

39) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of an EVRC codec and an SMV codec, the EVRC codec being active;
b) the audio communication apparatus including a plurality of codecs that can be selectively enabled to process audio data, the plurality of codecs of the audio communication apparatus that can be selectively enabled consist of an EVRC codec, an SMV codec, the EVRC codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.

40) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of an EVRC codec and an SMV codec, the EVRC codec being active;
b) the audio communication apparatus including a plurality of codecs that can be selectively enabled to process audio data, the plurality of codecs of the audio communication apparatus that can be selectively enabled consist of an SMV codec and an EVRC codec, the SMV codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.

41) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of an EVRC codec and an SMV codec, the EVRC codec being active;
b) the audio communication apparatus including a plurality of codecs that can be selectively enabled to process audio data, the plurality of codecs of the audio communication apparatus that can be selectively enabled consist of a Q13 codec, an EVRC codec and an SMV codec, the Q13 codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.

42) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of a Q13 codec, an EVRC codec and an SMV codec, the Q13 codec being active;
b) the audio communication apparatus including a plurality of codecs that can be selectively enabled to process audio data, the plurality of codecs of the audio communication apparatus that can be selectively enabled consist of a Q13 codec, an EVRC codec and an SMV codec, the Q13 codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.

43) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of a Q13 codec, an EVRC codec and an SMV codec, the Q13 codec being active;
b) the audio communication apparatus including a plurality of codecs that can be selectively enabled to process audio data, the plurality of codecs of the audio communication apparatus that can be selectively enabled consist of a Q13 codec and an EVRC codec, the Q13 codec being active;
c) said computer readable storage medium including data implementing a relationship selecting the EVRC codec for processing audio data transmitted between the audio communication apparatus and the remote entity at least in part on the basis of the plurality of codecs that can be selectively enabled and the active codec at the remote entity and at the audio communication apparatus.

44) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of a Q13 codec, an EVRC codec and an SMV codec, the Q13 codec being active;
b) the audio communication apparatus including a plurality of codecs that can be selectively enabled to process audio data, the plurality of codecs of the audio communication apparatus that can be selectively enabled consist of a Q13 codec and an SMV codec, the Q13 codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.

45) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the plurality of codecs of the remote entity that can be selectively enabled consist of a Q13 codec and an EVRC codec, the Q13 codec being active;
b) the audio communication apparatus including a plurality of codecs that can be selectively enabled to process audio data, the plurality of codecs of the audio communication apparatus that can be selectively enabled consist of a Q13 codec and an EVRC codec, the Q13 codec being active;
c) said computer readable storage medium including data implementing a relationship selecting the EVRC codec for processing audio data transmitted between the audio communication apparatus and the remote entity at least in part on the basis of the plurality of codecs that can be selectively enabled and the active codec at the remote entity and at the audio communication apparatus.

46) A computer readable storage medium for use in an audio communication apparatus for selecting at least one codec for processing audio data transmitted between the audio communication apparatus and a remote entity;
a) the remote entity including a plurality of codecs that can be selectively enabled to process audio data, the, plurality of codecs of the remote entity that can be selectively enabled consist of a Q13 codec and an SMV codec, the Q13 codec being active;
b) the audio communication apparatus including a plurality of codecs that can be selectively enabled to process audio data, the plurality of codecs of the audio communication apparatus that can be selectively enabled consist of a Q13 codec and an SMV codec, the Q13 codec being active;
c) said computer readable storage medium including data implementing a relationship selecting the SMV codec for processing audio data transmitted between the audio communication apparatus and the remote entity at least in part on the basis of the plurality of codecs that can be selectively enabled and the active codec at the remote entity and at the audio communication apparatus.
